(19) United States
(12) Patent Application Publication
(10) Pub. No.: US 2017/0145153 A1
(43) Pub. Date: May 25, 2017

(54) THERMOPLASTIC AROMATIC POLYESTERS COMPRISING TETRAHYDROFURAN-DIMETHANOL AND FURANDICARBOXYLIC ACID MOTIFS

(71) Applicant: ROQUETTE FRERES, Lestrem (FR)

(72) Inventors: Nicolas JACQUEL, LAMBERSART (FR); Gabriel DEGAND, LAMBRES (FR); Rene SAINT-LOUP, LOMME (FR)

(21) Appl. No.: 15/309,837

(22) PCT Filed: May 5, 2015
(86) PCT No.: PCT/FR2015/051187

§ 371 Date: Nov. 9, 2016

(30) Foreign Application Priority Data
May 9, 2014 (FR) 14 54176

(51) Int. Cl. C08G 63/42; C08G 63/78

(52) U.S. Cl. CPC C08G 63/42; C08G 63/78

(57) ABSTRACT

A thermoplastic polyester includes: at least one tetrahydrofuran-dimethanol diol motif (A); at least one furandicarboxylic acid motif (B); and at least one aliphatic diol motif (C). A method for producing polyester including the motifs (A), (B) et (C) is also described.

### FIELD OF THE INVENTION

The present invention relates to thermoplastic polyesters comprising tetrahydrofuran-dimethanol, aliphatic diol and aromatic diacid units. A subject of the invention is also a process for producing said polyester and the use of this polyester for producing compositions and articles.

### TECHNOLOGICAL BACKGROUND OF THE INVENTION

Because of their numerous advantages, plastics have become inescapable in the mass production of objects. Indeed, because of their thermoplastic nature, it is possible to produce objects of any type from these plastics, at a high rate.

Certain aromatic polyesters are thermoplastic and have thermal properties which allow them to be used directly for the manufacture of materials. They comprise aliphatic diol and aromatic diacid units. Among these aromatic polyesters, mention may be made of polyethyleneterephthalate (PET), which is a polyester comprising ethylene glycol and terephthalic acid units, used for example in the production of containers, packagings or else textile fibers.

According to the invention, the term “monomeric units” is intended to mean units, included in the polyester, which can be obtained after polymerization of a monomer. With regard to the ethylene glycol and terephthalic acid units included in PET, they can either be obtained by esterification reaction of ethylene glycol and terephthalic acid, or by transesterification reaction of ethylene glycol and terephthalic acid ester.

Moreover, the development of polyesters resulting from biological resources renewable in the short term has become an ecological and economic imperative, in the face of the exhaustion and of the increase in costs of fossil resources such as oil. One of the main concerns today in the polyester field is therefore that of providing polyesters of natural origin (biobased polyesters). Thus, groups such as Danone or Coca-Cola today market drink bottles made of partially biobased PET, this PET being manufactured from biobased ethylene glycol. One drawback of this PET is that it is only partially biobased, since the terephthalic acid is for its part derived from fossil resources.

Although polyesters comprising biobased terephthalic acid have already been described, for example in application WO 2013/034743 A1, the processes for synthesizing biobased terephthalic acid or biobased terephthalic acid ester remain too expensive at the current time for totally biobased PET to currently be a commercial success.

Other aromatic polyesters, comprising monomeric units other than terephthalic acid units, have been manufactured in order to replace PET.

Among the biobased polyesters, aromatic polyesters comprising aliphatic diol and 2,5-furandicarboxylic acid (FDCA) units, for instance polyethylene-co-furanoate (PEF), constitute an advantageous alternative since these polyesters have mechanical, optical and thermal properties close to those of PET. However, these FDCA-based polyesters are produced at a temperature that is generally lower than that of PET. This causes difficulties in obtaining PEFs of high molar mass.

Patent application US 2011/0282020 A1 describes a process for producing a polyester comprising 2,5-furandicarboxylic acid units in which:
in a first step, a 2,5-furandicarboxylic acid ester is reacted with a polyol in the presence of a transesterification catalyst comprising Sn(IV) so as to form a prepolymer;
then, at reduced pressure in a second step, the prepolymer thus formed is polymerized in the presence of a polycondensation catalyst comprising Sn(II) in order to increase the molar mass thereof and to form the polyester.

This process makes it possible to produce polyesters comprising FDCA units, and in particular to produce PEF, of high molar weight while retaining a low coloration, this being without requiring a step of purification after synthesis. The polymer thus has certain improved properties, for example greater mechanical properties or else a higher viscosity, thereby allowing it to be used for the same applications as those of PET. However, one of the problems with PEF is that it is, like PET, semicrystalline and has a crystallinity which remains high. It thus has impact-resistance and transparency properties which can therefore be insufficient.

Document US 20130095268 describes polyesters comprising 2,5-furandicarboxylic acid and cyclohexanedimethanol (CHDM), in particular 1,4-cyclohexanemethanol, units that are of use in the production of fibers, films, bottles, coatings or sheets. It is not indicated whether these polyesters are amorphous or semicrystalline. Moreover, when the polyester also comprises an aliphatic diol unit such as ethylene glycol, its glass transition temperature undergoes little or no modification whatever the amount of CHDM units in the polymer chain. This document does not teach that this polyester has a higher molar mass. Moreover, the applicant has been able to observe that some of the polymers described in said document are semicrystalline.

The applicant has managed to produce a polyester which is at least partially biobased and which has thermal properties that are entirely satisfactory so as to be able to be transformed by conventional thermoplastic techniques. This polyester has a low crystallinity, or even is totally amorphous. It also has a lower glass transition temperature than PEF, thereby allowing it, by virtue of its barely crystalline or noncrystalline nature, to be transformed at a lower temperature than the FDCA-based polyesters previously described.

### SUMMARY OF THE INVENTION

A subject of the invention is thus a thermoplastic polymer comprising:
at least one tetrahydrofuran-dimethanol (THFDM) diol unit (A);
at least one furandicarboxylic acid unit (B);
at least one aliphatic diol unit (C) other than the diol (A).

This polyester has properties which allow it to be readily transformed by thermoplastic transformation techniques. The heat-resistance properties and also its mechanical properties allow it to be used for the production of any type of plastic object.

Moreover, this polyester has a higher molar mass, compared with a polyester prepared according to the same process and comprising only aliphatic diol units of (C) type.

This is very surprising since the alcohol functions of the tetrahydrofuran-dimethanol diol exhibit considerable steric hindrance, generally greater than that of the other aliphatic diols, and in particular greater than the steric hindrance of the alcohol functions of a linear aliphatic diol such as ethylene glycol.

Document WO 2013/149222 describes a polyester comprising aliphatic diol and furandicarboxylic acid units. With respect to what is described in said document, the applicant has been able to select polyesters comprising diol units, aromatic acid units and also an additional selected diol of tetrahydrofuran-dimethanol (THFDM) type. As it happens, in addition to the advantages previously mentioned, the polyester according to the invention exhibits good thermomechanical stability at ambient temperature, contrary to similar polyesters comprising, in identical molar amounts (or even lower molar amounts, as is demonstrated in the examples section), polytetramethylene glycol in place of the selected diol.

### BRIEF DESCRIPTION OF THE FIGURES

FIG. 1 represents the glass transition temperature of a polyester comprising ethylene glycol, furanic acid and THFDM or CHDM units, as a function of the amount of THFDM or CHDM in the polyester.

FIG. 2 represents the ¹H NMR spectrum of a poly(ethylene-co-isosorbide-co-tetrahydrofuran-dimethanol furanoate).

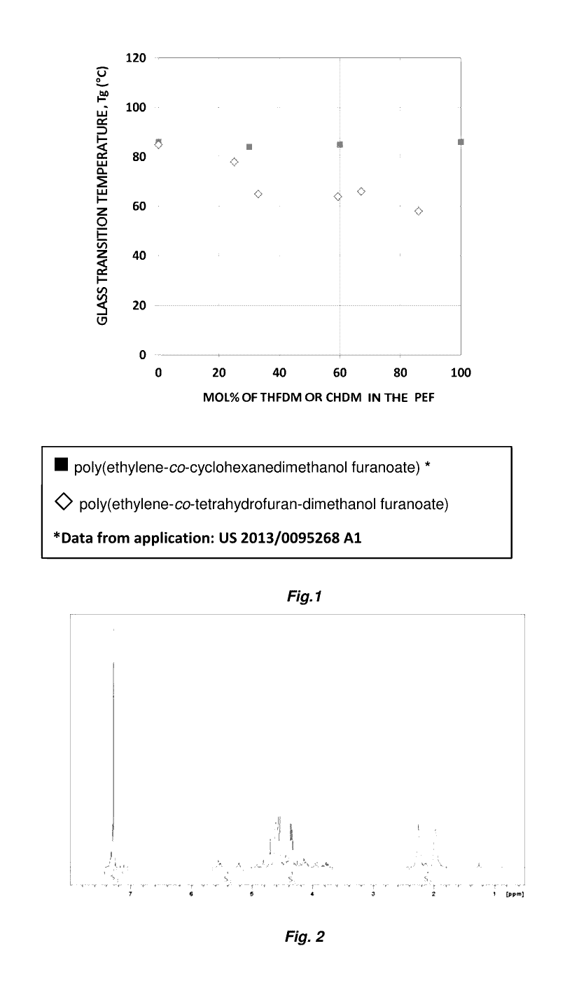

### DETAILED DESCRIPTION OF THE INVENTION

This polyester comprises at least one tetrahydrofuran-dimethanol unit (A), at least one particular aromatic unit (B) and at least one aliphatic diol (C) other than the diol (A).

The expression “comprises at least one unit (X)” is intended to mean that the polyester can comprise various types of units (X).

Thus, the tetrahydrofuran-dimethanol unit (A) can be a unit chosen from the units 2,5-tetrahydrofuran-dimethanol, 2,4-tetrahydrofuran-dimethanol, 2,3-tetrahydrofuran-dimethanol and 3,4-tetrahydrofuran-dimethanol or a mixture of these units.

Preferentially, it is a 2,5-tetrahydrofuran-dimethanol unit.

The 2,5-tetrahydrofuran-dimethanol unit is the following unit:

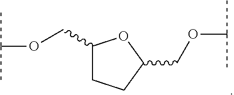

The polyester may also comprise a mixture of isomers of the diols mentioned above. For example, with regard to the 2,5-tetrahydrofuran-dimethanol unit, it may be, depending on its conformation, in the following isomeric forms:

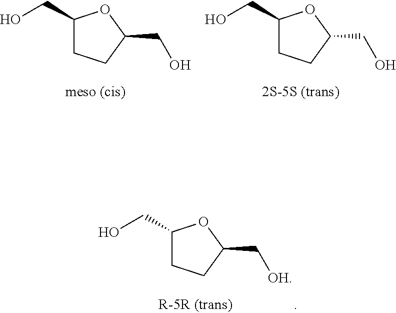 [SMILES: OC[C@@H]1CC[C@H](CO)O1 ; OC[C@@H]1CC[C@@H](CO)O1 ; OC[C@H]1CC[C@H](CO)O1]

When it is a mixture of isomers, it may be a mixture having a cis/trans ratio ranging from 1/99 to 99/1, for example from 90/10 to 99/1.

The tetrahydrofuran-dimethanol can be obtained by various reaction routes. It is preferably obtained at least partly from biobased resources. By way of example, the tetrahydrofuran-dimethanol can be obtained from diformylfuran as described in application WO 2014/049275 in the applicant's name.

The furandicarboxylic acid unit (B) can be a 2,5-furandicarboxylic acid unit, a 2,4-furandicarboxylic acid unit, a 2,3-furandicarboxylic acid unit, a 3,4-furandicarboxylic acid unit, or a mixture of these units. Preferably, the furandicarboxylic acid unit is the 2,5-furandicarboxylic acid unit.

More specifically, the term “2,5-furandicarboxylic acid unit” denotes, in the present application, a unit of formula:

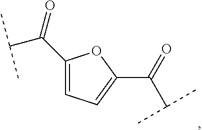

the dashed lines denoting the bonds by means of which the unit is connected to the rest of the polyester, this being irrespective of the monomer used to form said unit.

The furandicarboxylic acid may be biobased. One route for obtaining the furandicarboxylic acid is the oxidation of disubstituted furans, for example 5-hydroxymethyl furfural.

The polyester according to the invention comprises at least one unit (C) chosen from aliphatic diols other than the diol (A).

Whatever the variant, the polyester according to the invention may in particular comprise, relative to the total amount of diol units (A) and (C):
from 1 to 99 units (A), advantageously from 5 to 98;
and from 1 to 99 units (C), advantageously from 2 to 95.

The aliphatic diol unit may be at least one unit chosen from linear aliphatic diols (C1), cycloaliphatic diols (C2), branched aliphatic diols (C3) or a mixture of these units.

According to a first advantageous embodiment, the aliphatic diol unit (C) is a linear aliphatic diol unit (C1) or a mixture of these units.

The linear aliphatic diol unit (C1) has the following form:

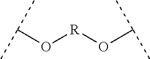

in which the R group is a linear aliphatic group, the dashed lines denoting the bonds by means of which the unit is connected to the rest of the polyester, this being irrespective of the monomer used to form said unit. Preferably, the R group is a saturated aliphatic group.

The diol (C1) is preferentially chosen from ethylene glycol, 1,3-propanediol, 1,4-butanediol, 1,5-pentanediol, 1,6-hexanediol, 1,8-octanediol, 1,10-decanediol, or a mixture of aliphatic diol units comprising at least one of these units, preferentially ethylene glycol and 1,4-butanediol, very preferentially ethylene glycol. The polyesters according to the invention comprising diols (C1) chosen from ethylene glycol and 1,4-butanediol are particularly preferred since they do not pose any toxicity problem, contrary to those based on 1,3-propanediol, which can comprise residual acrolein. Furthermore, these two preferred diols are highly industrially available. Preference is in particular given to ethylene glycol as diol (C1) because of the higher glass transition temperature of the polyester obtained therefrom in comparison with the polyesters obtained from the other diols (C1).

According to this first mode, the polyester according to the invention advantageously comprises, relative to the total amount of diol units (A) and (C1):
from 1 to 99 units (A), advantageously from 5 to 90, preferentially from 10 to 80, for example from 20 to 75;
and from 1 to 99 units (C1), advantageously from 10 to 95, preferentially from 20 to 90, for example from 25 to 80.

According to a second advantageous embodiment, the aliphatic diol unit (C) is at least a cycloaliphatic diol unit (C2) or a mixture of these units.

According to this second mode, the polyester according to the invention advantageously comprises, relative to the total amount of diol units (A) and (C2):
from 1 to 99 units (A), advantageously from 5 to 98, preferentially from 80 to 95;
and from 1 to 99 units (C2), advantageously from 2 to 95, preferentially from 5 to 20.

According to a first sub-variant, the unit (C2) is chosen from the following units:

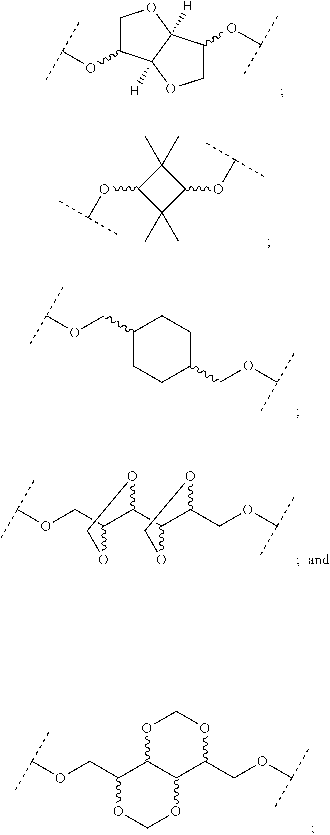

or a mixture of these units.

Advantageously, (C2) is a 1:4, 3:6-dianhydrohexitol unit chosen from:

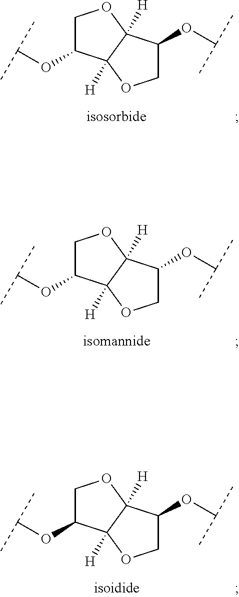

or a mixture of these units.

It is preferentially a unit:

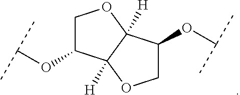

The isosorbide, isomannide and isoidide can thus be obtained respectively by dehydration of sorbitol, of mannitol and of iditol.

The synthesis of these dianhydrohexitols is well-known: various routes are described for example in the articles by Fletcher et al. (1,4,3,6-Hexitol dianhydride, I-isoidide, J Am Chem Soc, 1945, 67:1042-3 and also 1,4,3,6-Dianhydro-I-iditol and the structure of isomannide and isosorbide, J Am Chem Soc, 1946, 68:939-41), by Montgomery et al. (Anhydrides of polyhydric alcohols. IV. Constitution of dianhydrosorbitol, J Chem Soc, 1946, 390-3 &Anhydrides of polyhydric alcohols. IX. Derivatives of 1,4-anhydrosorbitol from 1,4,3,6-dianhydrosorbitol, J Chem Soc, 1948, 237-41), by Fleche et al. (Isosorbide. Preparation, properties and chemistry, Starch/Staerke 1986, 38:26-30), by Fukuoka et al. (Catalytic conversion of cellulose into sugar Alcohols, Angew Chem Int Ed, 2006, 45:5161-3), in U.S. Pat. No. 3,023,223.

The unit (C2) may also be a cyclobutanediol unit, for example a tetramethylcyclobutanediol unit, in particular a unit chosen from:

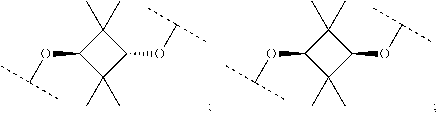

or a mixture of these units.

The unit (C2) may also be a cyclohexanedimethanol unit, in particular a unit chosen from the units 1,4-cyclohexanedimethanol, 1,2-cyclohexanedimethanol and 1,3-cyclohexanedimethanol or a mixture of these diols and of isomers of these diols. These diols may be in the cis or trans configuration. For example, in the case of a 1,4-cyclohexanedimethanol unit, they are units:

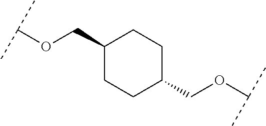

for the cis configuration;

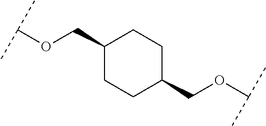

for the trans configuration;

The unit (C2) may also be chosen from:

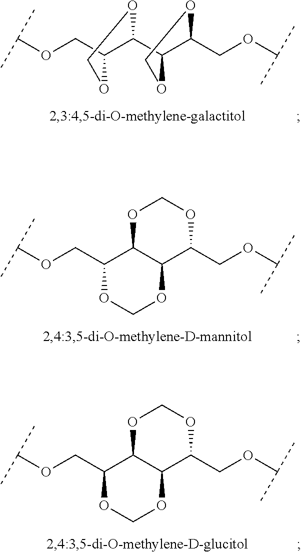

or a mixture of these units.

The 2,3:4,5-di-O-methylene-galactitol can for its part be obtained by acetalization then reduction of galactaric acid, as described by Lavilla et al. in Bio-based poly(butylene terephthalate) copolyesters containing bicyclic diacetalized galactitol and galactaric acid: Influence of composition on properties, Polymer, 2012, 53(16), 3432-3445. The 2,4:3,5-di-O-methylene-D-mannitol can for its part be obtained by acetalization of D-mannitol with formaldehyde, as described by Lavilla et al. in Bio-Based Aromatic Polyesters from a Novel Bicyclic Diol Derived from D-Mannitol, Macromolecules, 2012, 45, 8257-8266.

According to the invention, the polyester may comprise mixtures of units (C2) as described in the previous two sub-variants.

According to a third advantageous embodiment, the aliphatic diol unit (C) is a mixture of at least one linear aliphatic diol (C1) and of at least one cycloaliphatic diol unit (C2).

The diols (C1) and (C2) can be chosen from those previously listed.

The polyester according to the invention advantageously comprises, relative to the total amount of diol units (A) and (C):
from 1 to 98 units (A), advantageously from 5 to 95, preferentially from 15 to 90;
from 1 to 98 units (C1), advantageously from 2 to 60, preferentially from 4 to 50;
and from 1 to 98 units (C2), advantageously from 2 to 60, preferentially from 5 to 40.

In the case where the polyester comprises units (C3), the branched aliphatic diol unit has the following form:

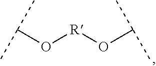

in which the R′ group is a branched aliphatic group, the dashed lines denoting the bonds by means of which the unit is connected to the rest of the polyester, this being irrespective of the monomer used to form said unit. Preferably, the R′ group is a saturated group.

The polyester according to the invention may comprise additional monomeric units other than the units (A), (B) and (C). Preferably, the amount of additional monomeric units is, relative to the total sum of the units of the polyester, less than 30%, most preferentially less than 10%. The polyester according to the invention may be free of additional monomeric unit.

The additional monomeric units may in particular be diether units such as diethylene glycol units. These diether units can originate from co-products of the polymerization process, i.e. they can originate for example from an etherification reaction between two glycols. In order to limit this etherification reaction, it is possible to add to the reactor a base that limits this phenomenon, said base possibly being sodium acetate, sodium hydroxide, tetramethylammonium hydroxide, tetraethylammonium hydroxide or a mixture of these bases. Preferably, the amount of diether units is, relative to the total sum of the units of the polyester, less than 10%. The polyester according to the invention may be free of diether unit.

The additional monomeric units may also be additional diacid units other than the aromatic units (B). By way of example, these units may be saturated aliphatic diacid units. As saturated cyclic aliphatic diacid unit, mention may be made of the 1,4-cyclohexanedioic acid unit. Advantageously, the aliphatic diacid unit is a linear saturated aliphatic diacid unit. These units may be chosen from succinic acid, glutaric acid, adipic acid, pimelic acid, suberic acid, azelaic acid and sebacic acid units or a mixture of these diacids. Preferably, the aliphatic diacid is chosen from succinic acid and adipic acid, most preferentially succinic acid. Preferably, the amount of additional diacid units is, relative to the total sum of the units of the polyester, less than 30%, most preferentially less than 10%. The polyester according to the invention may be free of additional diacid unit.

The additional monomeric units may also be hydroxy acid units. By way of example, the hydroxy acid units may be glycolic acid, lactic acid, hydroxybutyric acid, hydroxycaproic acid, hydroxyvaleric acid, 7-hydroxyheptanoic acid, 8-hydroxyoctanoic acid, 9-hydroxynonanoic acid, hydroxymethylfurancarboxylic acid and hydroxybenzoic acid units or a mixture of these hydroxy acids. With regard to these hydroxy acid units, they are capable of being obtained from a hydroxy acid or from a dilactone such as glycolide or lactide. Preferably, the amount of hydroxy acid units is, relative to the total sum of the units of the polyester, less than 10%. The polyester according to the invention may be free of hydroxy acid unit.

The polyester according to the invention may also comprise chain extender units. The term “chain extender” is intended to mean a unit capable of being obtained using a monomer comprising two functions other than the hydroxyl, carboxylic acid and carboxylic acid ester functions, and capable of reacting with these same functions. The functions may be isocyanate, isocyanurate, caprolactam, caprolactone, carbonate, epoxy, oxazoline and imide functions, it being possible for said functions to be identical or different. By way of chain extenders that can be used in the present invention, mention may be made of:
diisocyanates, preferably methylenediphenyl diisocyanate (MDI), isophorone diisocyanate (IPDI), dicyclohexylmethane diisocyanate (H12MDI), toluene diisocyanate (TDI), naphthalene diisocyanate (NDI), hexamethylene diisocyanate (HMDI) or lysine diisocyanate (LDI), the aliphatic diisocyanate having a molar mass of 600 g/mol obtained from fatty diacid dimers (DDI®1410 Diisocyanate),
diisocyanate dimers, trimers and tetramers,
polymers termed “isocyanate-free” resulting from a reaction of a diol or of an amine with a diisocyanate under conditions such that the prepolymer contains an isocyanate function at each of its ends (α,ω-functional or telechelic polymer) without it being possible for free diisocyanate to be detected,
dialkyl carbonates, in particular dianhydrohexitol dialkyl carbonates, and in particular isosorbide dialkyl carbonates,
dicarbamoylcaprolactams, preferably 1,1′-carbonyl-bis-caprolactam, dicarbamoylcaprolactones,
diepoxides,
compounds comprising an epoxide function and a halide function, preferably epichlorohydrin,
heterocyclic compounds, preferably bis-oxazolines, bis-oxazolin-5-ones and bis-azalactones,
methylenic or ethylenic diester derivatives, preferably methyl or ethyl carbonate derivatives,
any mixtures of at least any two of the abovementioned products.

Preferably, the amount of chain extender units is, relative to the total sum of the units of the polyester, less than 10%. The polyester according to the invention may be free of chain extender unit.

The monomeric units may also be polyfunctional units. The term “polyfunctional unit” is intended to mean a unit which can be obtained by reaction of a co-monomer capable of reacting with the hydroxide and/or carboxylic acid and/or carboxylic acid ester functions and the functionality of which is greater than 2. The reactive functions of these branching agents may be hydroxide, carboxylic acid, anhydride, isocyanate, isocyanurate, caprolactam, caprolactone, carbonate, epoxy, oxazoline and imide functions, it being possible for said functions to be identical or different, preferably carboxylic acid, hydroxide, epoxide or isocyanate functions, most preferentially carboxylic acid or hydroxide functions. The functionality of these branching agents may be from 3 to 6, preferably from 3 to 4. Among the branching agents conventionally used, mention may be made of: malic acid, citric acid or isocitric acid, tartaric acid, trimesic acid, tricarballylic acid, cyclopentanetetracarboxylic acid, trimellitic anhydride, pyromellitic monoanhydride or dianhydride, glycerol, pentaerythritol, dipentaerythritol, monoanhydrosorbitol, monoanhydromannitol, epoxide oils, dihydroxystearic acid, trimethylolpropane, ethers of these polyols, for instance glyceryl propoxylate (sold under the name Voranol 450 by Dow Chemical), polymers which have epoxide side functions, triisocyanates, tetraisocyanates and also the respective homopolymers of di-, tri- and tetraisocyanates that exist, polyanhydrides, and alkoxysilanes, preferably tetraethoxysilane.

Preferably, the amount of polyfunctional units is, relative to the total sum of the units of the polyester, less than 10%. The polyester according to the invention may be free of polyfunctional unit.

According to another mode of the invention, the polyester according to the invention comprises, relative to the total amount of the units:
from 5% to 55% of units (A);
from 40% to 60% of units (B);
from 1% to 50% of units (C);
from 0% to 10% of diether units;
from 0% to 30% of additional diacid units other than (B), preferentially from 0% to 10%;
from 0% to 10% of hydroxy acid units;
from 0% to 10% of chain extender units;
from 0% to 10% of polyfunctional units.

The polyester according to the invention may be partially biobased, or even totally biobased. In other words, it is partly or totally obtained from monomers that are at least partially biobased.

The polyester may be a random copolymer or a block copolymer.

Preferably, the polyester according to the invention has a molar ratio of units (B)/((A)+(C)) ranging from 60/40 to 40/60, advantageously from 55/45 to 45/55.

The amounts of various units in the polyester can be determined by ¹H NMR. Those skilled in the art can easily find the analysis conditions for determining the amounts of each unit of the polyester. FIG. 2 presents the NMR spectrum of the poly(ethylene-co-isosorbide-co-tetrahydrofuran-dimethanol furanoate). The chemical shifts relating to ethylene glycol are between 4.4 and 5.0 ppm, the chemical shifts relating to the furan ring are between 7.2 and 7.5 ppm, the chemical shifts relating to tetrahydrofuran-dimethanol are between 3.6 and 5.0 ppm and between 1.8 and 2.4 ppm and the chemical shifts relating to isosorbide are around 4.2 ppm, 4.8 ppm, 5.2 ppm and 5.6 ppm. The integration of each signal makes it possible to determine the amount of each unit of the polyester.

Preferably, the polyester according to the invention has a weight-average molar mass greater than 7500 g/mol, preferably greater than 10 000 g/mol, most preferentially greater than 20 000 g/mol.

The molar mass of the polyester can be determined by conventional methods, for instance by size exclusion chromatography (SEC) in a mixture of chloroform and 1,1,1,3,3,3-hexafluoro-2-propanol in a 98/2 volume ratio. The signal can then be detected by a differential refractometer calibrated with poly(methyl methacrylate) standards.

Advantageously, the glass transition temperature of the polymer according to the invention is greater than or equal to 50° C., preferably greater than or equal to 55° C., or even greater than or equal to 60° C. This makes it possible to use said polymer for forming numerous types of objects which have heat resistance sufficient to be able to be used in numerous applications. The glass transition temperature of the polyester can be measured by conventional methods, in particular using differential scanning calorimetry (DSC) using a heating rate of 10 K/min. The experimental protocol is described in detail in the examples section hereinafter.

Advantageously, the polyester according to the invention has a glass transition temperature of less than or equal to 85° C., advantageously less than or equal to 80° C., preferably less than or equal to 75° C. This makes it possible to transform the polymer at a lower temperature than a PEF or a PEFg.

The polyester which is the subject of the present invention may be semicrystalline or amorphous. Advantageously, the polyester has a degree of crystallinity of less than 50%, preferentially less than 35%. The crystallinity of the polyester can be determined by DSC by heating a sample from 10 to 280° C. (10 K/min), then cooling to 10° C. (10 K/min). Preferably, the polyester according to the invention is amorphous; in other words, its crystallinity is zero. In this case, it has an improved impact resistance and improved optical properties, this being without requiring the use of a specific impact modifier or of a clarifying agent.

The invention also relates to a process for producing thermoplastic polyester, which comprises:
a step of introducing, into a reactor, monomers comprising at least one tetrahydrofuran-dimethanol diol (A), at least furandicarboxylic acid (B) and/or a diester of this acid and at least one aliphatic diol (C) other than the diol (A); and
a step of polymerizing the monomers so as to form the polyester, comprising:
   a first stage during which the reaction medium is stirred at a temperature ranging from 140 to 210° C. in order to form oligomers;
   a second stage during which the oligomers formed are stirred under vacuum, at a temperature ranging from 200 to 275° C. in order to form the polyester;
a step of recovering the polyester at the end of the polymerizing step.

Using this process, it is possible to obtain a polyester which has a glass transition temperature sufficient to be able to be used as a plastic for the production of objects of any type.

The various monomers mentioned above can be used to carry out the process according to the invention.

With regard to the monomers introduced into the reactor, they can be introduced into the reactor all at once or in several steps, in the form of a mixture or separately.

The diols (A) and (C) that are of use in the process of the invention have been described above in the corresponding polyester unit parts.

With regard to the diacid units, including the units (B), they can be obtained from the diacid, but it is also possible to replace this diacid with monomers that differ only in that the carboxylic acid function of the monomer is replaced with a carboxylic acid ester function. In this case, furandicarboxylic acid alkyl diesters, and in particular 2,5-furandicarboxylic acid alkyl diesters, are preferably used as precursor of the unit B. Even more preferentially, use is made of the methyl or ethyl diesters, most preferentially methyl diesters, that is to say 2,5-dimethyl furanoate.

With regard to the additional monomeric units, they can be obtained from the monomers mentioned as units of the polyester. In the case of units bearing acid functions, they can be obtained via monomers that differ from the mentioned monomers only in that the carboxylic acid function of the monomer is replaced with a carboxylic acid ester function or optionally, when these monomers exist, with an anhydride function.

Preferably, relative to the total moles of monomers (A), (B) and (C) introduced into the reactor, the molar percentage of acid and/or of diester (B) ranges from 25% to 45%.

Indeed, in the process according to the invention, an excess of diol is preferably used in order to carry out the synthesis of the polyester. This makes it possible to accelerate the reaction and also to increase the final molar mass of the polyester thus formed.

Those skilled in the art will be able to adjust the amounts of diol (A) and (C) introduced into the reactor in order to obtain the respective proportions in the various diols of the polyesters according to the invention previously described. For example, relative to the total moles of diol (A) and (C), at least 1 mol % and at most 99 mol % consist of diol (A), advantageously from 5 to 98%.

Preferably, the temperature during the first stage of polymerization ranges from 150 to 200° C. Preferably, this first stage is carried out in an inert gas atmosphere, this gas possibly in particular being dinitrogen. This first stage can be carried out under a gas stream. It can also be carried out under pressure, for example at a pressure of between 1.05 and 8 bar. Preferably, when the monomer (B) is of acid type, the pressure ranges from 3 to 8 bar. Preferably, when the monomer (B) is of ester type, the pressure ranges from 1.05 to 3 bar.

Prior to the first stage, a reactor deoxygenation step is preferentially carried out. It can be carried out for example by producing a vacuum in the reactor and then by introducing an inert gas such as nitrogen into the reactor. This vacuum-inert gas introduction cycle can be repeated several times, for example from 3 to 5 times. Preferably, this vacuum-nitrogen cycle is carried out at a temperature between 60 and 80° C. so that the reagents, and in particular the bicyclic diols, are totally molten. This deoxygenation step has the advantage of improving the coloration properties of the polyester obtained at the end of the process.

The second stage of polymerization is carried out under vacuum, preferably at a pressure below 10 mbar, most preferentially below 1 mbar.

Preferably, the temperature during the second stage of polymerization ranges from 220 to 270° C.

According to the invention, the first stage of the polymerization step preferably has a duration ranging from 1 to 5 hours. Advantageously, the second stage has a duration ranging from 2 to 6 hours.

The process according to the invention comprises a step of polymerization in the presence of a catalyst.

A transesterification catalyst is advantageously used during this stage. This transesterification catalyst can be chosen from tin derivatives, preferentially tin(IV) derivatives, titanium derivatives, zirconium derivatives, hafnium derivatives, zinc derivatives, manganese derivatives, calcium derivatives and strontium derivatives, organic catalysts such as para-toluenesulfonic acid (PTSA) or methanesulfonic acid (MSA), or a mixture of these catalysts. By way of examples of such compounds, mention may be made of those given in application US 2011282020A1 in paragraphs [0026] to [0029], and on page 5 of application WO 2013/062408 A1.

Preferably, a tinIV derivative, a titanium derivative, a zinc derivative or a manganese derivative is used during the first stage of transesterification.

At the end of transesterification, the catalyst of the first stage can be optionally blocked by adding phosphorous acid or phosphoric acid, or else, as in the case of tin(IV), reduced with phosphites such as triphenyl phosphite or tris(nonylphenyl) phosphites or those cited in paragraph [0034] of application US 2011 282020A1.

The second stage of polymerization (polycondensation) can optionally be carried out with the addition of an additional catalyst. This catalyst is advantageously chosen from tin derivatives, preferentially tin(II) derivatives, and derivatives of titanium, zirconium, germanium, antimony, bismuth, hafnium, magnesium, cerium, zinc, cobalt, iron, manganese, calcium, strontium, sodium, potassium, aluminum or lithium, or of a mixture of these catalysts. By way of example of such compounds, mention may be made of those given in patent EP 1 882 712 B1 in paragraphs [0090] to [0094].

Preferably, the catalyst is a tin(II), titanium, germanium or antimony derivative.

Most preferentially, during the first stage and the second stage of polymerization, a titanium-based catalyst is used.

The polyester recovered during the final step of the process advantageously has the characteristics given above.

The process according to the invention comprises a step of recovering the polyester at the end of the polymerization step. The polyester can be recovered by extracting it from the reactor in the form of a molten polymer rod. This rod can be converted into granules using conventional granulation techniques.

The process according to the invention can also comprise, after the polyester recovery step, a step of polymerization in the solid state.

A subject of the invention is also a polyester that can be obtained according to the process of the invention.

The invention also relates to a composition comprising, in addition to the polyester according to the invention, at least one additive or one additional polymer or a mixture thereof.

Thus, the composition according to the invention can also comprise, as additive, fillers or fibers of organic or inorganic nature, which are optionally nanometric and optionally functionalized. They may be silicates, zeolites, glass fibers or beads, clays, mica, titanates, silicates, graphite, calcium carbonate, carbon nanotubes, wood fibers, carbon fibers, polymer fibers, proteins, cellulose-based fibers, lignocellulosic fibers and non-destructured granular starch. These fillers or fibers can make it possible to improve the hardness, the rigidity or the water- or gas-permeability. The composition may comprise from 0.1% to 75% by weight of fillers and/or fibers relative to the total weight of the composition, for example from 0.5% to 50%. The composition may also be of composite type, i.e. may comprise large amounts of these fillers and/or fibers.

The additive that is of use in the composition according to the invention may also comprise opacifiers, dyes and pigments. They may be chosen from cobalt acetate and the following compounds: HS-325 Sandoplast® Red BB (which is a compound bearing an azo function, also known under the name Solvent Red 195), HS-510 Sandoplast® Blue 2B which is an anthraquinone, Polysynthren® Blue R, and Clariant® RSB Violet.

The composition may also comprise, as additive, a processing aid, for reducing the pressure in the processing tool. A demolding agent which makes it possible to reduce adhesion to the materials for forming the polyester, such as the molds and the calendering rolls, can also be used. These agents can be selected from fatty acid esters and fatty acid amides, metal salts, soaps, paraffins or hydrocarbon-based waxes. Particular examples of these agents are zinc stearate, calcium stearate, aluminum stearate, stearamide, erucamide, behenamide, beeswaxes or candelilla wax.

The composition according to the invention may also comprise other additives, such as stabilizers, for example light stabilizers, UV-stabilizers and heat stabilizers, fluidizing agents, flame retardants and antistatics. It may also comprise primary and/or secondary antioxidants. The primary antioxidant may be a sterically hindered phenol, such as the compounds Hostanox® 0 3, Hostanox® 0 10, Hostanox® 0 16, Ultranox® 210, Ultranox®276, Dovernox® 10, Dovernox® 76, Dovernox® 3114, Irganox® 1010 or Irganox® 1076. The secondary antioxidant may be trivalent phosphorus compounds such as Ultranox® 626, Doverphos® S-9228, Hostanox® P-EPQ or Irgafos® 168.

The composition may also comprise an additional polymer, different than the polyester according to the invention. This polymer may be chosen from polyamides, polyesters other than the polyester according to the invention, polystyrene, styrene copolymers, styrene-acrylonitrile copolymers, styrene-acrylonitrile-butadiene copolymers, poly(methyl methacrylate)s, acrylic copolymers, poly(ether-imide)s, poly(phenylene oxide)s, such as poly(2,6-dimethylphenylene oxide), poly(phenylene sulfate)s, poly(ester-carbonate)s, polycarbonates, polysulfones, polysulfone ethers, polyether ketones, and mixtures of these polymers.

The composition may also comprise, as additional polymer, a polymer which makes it possible to improve the impact properties of the polymer, in particular functional polyolefins such as functionalized ethylene or propylene polymers and copolymers, core-shell copolymers or block copolymers.

The compositions according to the invention may also comprise polymers of natural origin, such as starch, cellulose, chitosans, alginates, proteins such as gluten, pea proteins, casein, collagen, gelatin or lignin, it being possible for these polymers of natural origin to optionally be physically or chemically modified. The starch can be used in destructured or plasticized form. In the latter case, the plasticizer may be water or a polyol, in particular glycerol, polyglycerol, isosorbide, sorbitan, sorbitol, mannitol or else urea. The process described in document WO 2010/010282 A1 may in particular be used to prepare the composition.

The composition according to the invention may be produced by conventional thermoplastic transformation methods. These conventional methods comprise at least one step of mixing in the molten or softened state of the polymers and a step of recovering the composition. This process may be performed in paddle or rotor internal mixers, external mixers, or single-screw or twin-screw corotating or counter-rotating extruders. However, it is preferred to prepare this mixture by extrusion, in particular using a corotating extruder.

The mixing of the constituents of the composition can be carried out under an inert atmosphere.

In the case of an extruder, the various constituents of the composition may be introduced by means of feed hoppers located along the extruder.

The invention also relates to an article comprising the polyester or the composition according to the invention.

This article may be of any type and may be obtained using conventional transformation techniques.

It may be, for example, fibers or threads that are of use in the textile industry or other industries. These fibers or threads may be woven so as to form fabrics, or else nonwovens.

The article according to the invention may also be a film or a sheet. These films or sheets may be produced by calendering, film cast extrusion or blown film extrusion.

The article according to the invention may also be a container for transporting gases, liquids and/or solids. The containers concerned may be babies' bottles, flasks, bottles, for example sparkling or still water bottles, juice bottles, soda bottles, carboys, alcoholic drink bottles, small bottles, for example small medicine bottles, small bottles for cosmetic products, dishes, for example for ready meals, microwave dishes, or else lids. These containers may be of any size. They may be produced by extrusion-blow molding, thermoforming or injection-blow molding.

These articles may also be optical articles, i.e. articles requiring good optical properties, such as lenses, disks, transparent or translucent panels, optical fibers, films for LCD screens or else window panes. These optical articles have the advantage that they can be placed close to light sources and therefore to heat sources, while retaining excellent dimensional stability and good resistance to light.

The articles may also be multilayer articles, at least one layer of which comprises the polymer or the composition according to the invention. These articles may be produced via a process comprising a step of coextrusion in the case where the materials of the various layers are placed in contact in the molten state. By way of example, mention may be made of the techniques of tube coextrusion, profile coextrusion, coextrusion blow-molding of a bottle, a small bottle or a tank, generally collated under the term “coextrusion blow-molding of hollow bodies, coextrusion blow-molding also known as film blowing, and cast coextrusion.

They may also be produced according to a process comprising a step of applying a layer of molten polyester onto a layer based on organic polymer, metal or adhesive composition in the solid state. This step may be performed by pressing, by overmolding, by lamination, extrusion-lamination, coating, extrusion-coating or spreading.

The invention will now be illustrated in the examples hereinafter. It is specified that these examples do not in any way limit the present invention.

### EXAMPLES

### Reagents

For the illustrative examples presented below, the following reagents were used:

### Monomer A:

2,5-tetrahydrofuran-dimethanol (THFDM) (purity 99.6%). Obtained by hydrogenation of 2,5-furan-dimethanol (95%, Pennakem) on Raney Ni at 110° C. and 70 bar, then purification by distillation.

### Monomer B: Precursor of the Unit “B”:

2,5-dimethyl furanoate (purity>99%) from Satachem

### Monomer (C):

Ethylene glycol (purity >99.8%) from Sigma-Aldrich

Isosorbide (purity >99.5%) Polysorb® P from Roquette Frères

2,2,4,4-tetramethyl-1,3-cyclobutanediol (purity >98%) from Chemical Point, cis/trans ratio=50/50

### Other Monomers:

1,4-cyclohexanedimethanol (CHDM): cis/trans ratio: 30/70 (purity>99%) from Sigma Aldrich

PTMEG: polytetramethylene glycol from Sigma Aldrich, 1000 g/mol

### Catalysts:

Titanium isopropoxide (>99.99%) from Sigma Aldrich

Titanium tetrabutoxide (>97%) from Sigma Aldrich

### Analytical Techniques

### NMR

The ¹H NMR of the polyester samples was carried out using a Brucker 400 MHz spectrometer equipped with a QNP probe. Prior to the analysis, 15 mg of the polyester sample were dissolved in 0.6 ml of deuterated chloroform (CDCl₃) and 0.1 ml of tetrafluoroacetic acid (d1-TFA). Integration of the peaks corresponding to the various units in particular made it possible to calculate the A/C and A/C1/C2 ratios given in tables 1 and 2.

### Size Exclusion Chromatography

The molar mass of the polymer was evaluated by size exclusion chromatography (SEC) in a mixture of chloroform and 1,1,1,3,3,3-hexafluoro-2-propanol (98:2 vol %). The polyester samples were dissolved at a concentration of 1 g·l⁻¹, and were then eluted at a flow rate of 0.75 ml·min⁻¹. The signal acquisition was carried out using a refractometric detector (Agilent RI-1100a) and the weight-average molar masses (Mw) were subsequently evaluated using poly(methyl methacrylate) (PMMA) standards.

### DSC

The thermal properties of the polyesters were measured by differential scanning calorimetry (DSC): The sample is first of all heated from 10 to 280° C. (10° C.min⁻¹), cooled to 10° C. (10° C.min⁻¹) and then reheated to 280° C. under the same conditions as the first step. The glass transition was taken at the mid-point of the second heating.

### Preparation and Characterization of Thermoplastic Polyesters

In the protocols which follow, the parts of reagents are given in proportions by weight.

### Example According to the Invention (Ex. 1)

50 parts of dimethyl furanoate, 28.65 parts of ethylene glycol, 10.92 parts of tetrahydrofuran-dimethanol and 4.2 parts of a solution of titanium isopropoxide in toluene (1% by weight of titanium isopropoxide) are placed in a reactor. The mixture is stirred by mechanical stirring at 150 rpm and is placed in an oven heated to 180° C. over the course of 15 min under a nitrogen stream. Still under a nitrogen stream, the oven is then maintained at 180° C. for 1 h, before being again heated to 210° C. over the course of 1 h. This temperature is maintained for 2 h in order to remove the maximum amount of methanol.

Following this, the oven temperature is increased to 260° C., the pressure is reduced over the course of 90 min to 0.7 mbar and the stirring speed is reduced to 50 rpm. These conditions are maintained for 3 h.

The characteristics of the polymer formed are reported in table 1 below.

### Example According to the Invention (Ex. 2)

50 parts of dimethyl furanoate, 30 parts of ethylene glycol, 11 parts of tetrahydrofuran-dimethanol and 4.5 parts of a solution of titanium isopropoxide in toluene (1% by weight of titanium isopropoxide) are placed in a reactor. The mixture is stirred using a magnetic bar and is heated to 160° C. over the course of 30 min under a nitrogen stream. Still under a nitrogen stream, the mixture is then maintained at 160° C. for 1 h, before being again heated to 190° C. over the course of 30 min. This temperature is maintained for 2 h in order to remove the maximum amount of methanol.

Following this, the reactor temperature is increased to 240° C., and the pressure is reduced over the course of 90 min to 0.7 mbar with magnetic stirring. These conditions are maintained for 3 h.

The characteristics of the polymer formed are reported in table 1 below.

### Example According to the Invention (Ex. 3)

50 parts of dimethyl furanoate, 23 parts of ethylene glycol, 23.3 parts of tetrahydrofuran-dimethanol and 4.3 parts of a solution of titanium isopropoxide in toluene (1% by weight of titanium isopropoxide) are placed in a reactor. The mixture is stirred using a magnetic bar and is heated to 160° C. over the course of 30 min under a nitrogen stream. Still under nitrogen stream, the mixture is then maintained at 160° C. for 1 h, before being again heated to 190° C. over the course of 30 min. This temperature is maintained for 2 h in order to remove the maximum amount of methanol.

Following this, the reactor temperature is increased to 240° C., and the pressure is reduced over the course of 90 min to 0.7 mbar with magnetic stirring. These conditions are maintained for 3 h.

The characteristics of the polymer formed are reported in table 1 below.

### Example According to the Invention (Ex. 4)

50.1 parts of dimethyl furanoate, 20 parts of ethylene glycol, 28.7 parts of tetrahydrofuran-dimethanol and 4.4 parts of a solution of titanium isopropoxide in toluene (1% by weight of titanium isopropoxide) are placed in a reactor. The mixture is stirred using a magnetic bar and is heated to 160° C. over the course of 30 min under a nitrogen stream. Still under nitrogen stream, the mixture is then maintained at 160° C. for 1 h, before being again heated to 190° C. over the course of 30 min. This temperature is maintained for 2 h in order to remove the maximum amount of methanol.

Following this, the reactor temperature is increased to 240° C., and the pressure is reduced over the course of 90 min to 0.7 mbar with magnetic stirring. These conditions are maintained for 3 h.

The characteristics of the polymer formed are reported in table 1 below.

### Example According to the Invention (Ex. 5)

49.8 parts of dimethyl furanoate, 13.2 parts of ethylene glycol, 44 parts of tetrahydrofuran-dimethanol and 4.8 parts of a solution of titanium isopropoxide in toluene (1% by weight of titanium isopropoxide) are placed in a reactor. The mixture is stirred using a magnetic bar and is heated to 160° C. over the course of 30 min under a nitrogen stream. Still under a nitrogen stream, the mixture is then maintained at 160° C. for 1 h, before being again heated to 190° C. over the course of 30 min. This temperature is maintained for 2 h in order to remove the maximum amount of methanol.

Following this, the reactor temperature is increased to 240° C., and the pressure is reduced over the course of 90 min to 0.7 mbar with magnetic stirring. These conditions will be maintained for 3 h.

The characteristics of the polymer formed are reported in table 1 below.

### Comparative Example (CP1)

49.9 parts of dimethyl furanoate, 33.7 parts of ethylene glycol and 4.6 parts of a solution of titanium isopropoxide in toluene (1% by weight of titanium isopropoxide) are placed in a reactor. The mixture is stirred using a magnetic bar and is heated to 160° C. over the course of 30 min under a nitrogen stream. Still under a nitrogen stream, the mixture is then maintained at 160° C. for 1 h, before being again heated to 190° C. over the course of 30 min. This temperature is maintained for 2 h in order to remove the maximum amount of methanol.

Following this, the reactor temperature is increased to 240° C., and the pressure is reduced over the course of 90 min to 0.7 mbar with magnetic stirring. These conditions are maintained for 3 h.

The characteristics of the polymer formed are reported in table 1 below.

### Comparative Example (CP2)

50 parts of dimethyl furanoate, 23.6 parts of ethylene glycol, 23.6 parts of cyclohexanedimethanol and 8.42 parts of a solution of titanium tetrabutoxide in toluene (1% by weight of titanium isopropoxide) are placed in a reactor. The mixture is stirred by mechanical stirring at 150 rpm and is placed in an oven heated to 160° C. over the course of 15 min under a nitrogen stream. Still under a nitrogen stream, the oven is then maintained at 160° C. for 1 h, before being again heated to 190° C. over the course of 1 hour. This temperature is maintained for 2 h in order to remove the maximum amount of methanol.

Following this, the oven temperature is increased to 260° C., the pressure is reduced over the course of 90 min to 0.7 mbar and the stirring speed is reduced to 50 rpm. These conditions are maintained for 3 h.

The characteristics of the polymer formed are reported in table 1 below.

### Comparative Example (CP3)

50 parts of dimethyl furanoate, 28 parts of ethylene glycol, 110 parts of polytetramethylene glycol and a solution of titanium isopropoxide in toluene are placed in a reactor. The mixture is stirred by mechanical stirring at 150 rpm and is placed in an oven heated to 180° C. over the course of 15 min under a nitrogen stream. Still under a nitrogen stream, the oven is then maintained at 180° C. for 1 h, before being again heated to 210° C. over the course of 1 h. This temperature is maintained for 2 h in order to remove the maximum amount of methanol.

Following this, the oven temperature is increased to 260° C., the pressure is reduced over the course of 90 min to 0.7 mbar and the stirring speed is reduced to 50 rpm. These conditions are maintained for 3 h.

The characteristics of the polymer formed are reported in table 1 below.

TABLE 1
Properties of the polyesters according to the invention and comparative
polyesters: effect of tetrahydrofuran on polyesters of poly(ethylene-
co-tetrahydrofuran-dimethanol furanoate) type

| | | | | A or CHDM or | |
|---|---|---|---|---|---|
| | Tm (° C.) (or | Tc (° C.) (or | Tg | PTMEG/C | Mw |
| Ex. | amorphous) | amorphous) | (° C.) | (mol/mol) | (g/mol) |
| 1 | Amorphous | Amorphous | 78 | 24.5/75.5 | 22 350 |
| 2 | Amorphous | Amorphous | 64.8 | 32.5/67.5 | 44 000 |
| 3 | Amorphous | Amorphous | 64.2 | 59.3/40.7 | 52 150 |
| 4 | Amorphous | Amorphous | 65.6 | 66.9/33.1 | 103 850 |
| 5 | Amorphous | Amorphous | 58.4 | 86.1/14.9 | 128 250 |
| CP1 | 218 | 176 | 85 | 0/100 | 18 450 |
| CP2 | 208 | 175 | 76 | 62.4(CHDM)/37.6 | 83 850 |
| CP3 | NM | NM | <−15° C. | 6(PTMEG)/94 | 11 100 |
| | (semicrystalline) | (semicrystalline) | | | |

NM: not measured

The tests show that:
the use of diols of THFDM type made it possible to increase the molar mass of the polyester obtained (cf CP1 and CP3 vs Ex1 to 5 or CP2 vs Ex4);
at a comparable amount of cycloaliphatic monomer, the polyester according to the invention has a lower glass transition temperature, thereby making it possible for it to be transformed at a lower temperature. This glass transition temperature is lower than that of PET, but the polyester according to the invention remains entirely satisfactory for numerous applications.

The applicant also synthesized, in comparative example 3, a polyester comprising PTMEG such as the polyester described in example 4 of application WO 2013149222. If the polyester of example 1 is compared with that of comparative example 3, it is noted that the glass transition temperature of the polyester according to the invention is much higher. This is the case even though the molar proportion of diol other than the linear diol is much lower for the comparative polyester comprising PTMEG than for the polyester according to the invention which comprises THFDM (6% for PTMEG compared with 24.5% for THFDM). Furthermore, the comparative polyester is semicrystalline.

In comparison, the polyesters of the examples according to the invention all have a glass transition temperature much higher than 25° C. and therefore a thermomechanical stability at ambient temperature that is improved compared with that of the same polyesters comprising PTMEG in place of THFDM.

Furthermore, contrary to all of the examples of polyesters according to the invention which are amorphous, some polyesters comprising furandicarboxylic acid and cyclohexanedimethanol (CHDM) units are semicrystalline; it is therefore necessary to transform said polyesters at a temperature exceeding the melting temperature thereof. The same is true for the polyesters described in application WO 2013149222.

### Example According to the Invention (Ex. 6)

49.7 parts of dimethyl furanoate, 12.7 parts of ethylene glycol, 36.8 parts of tetrahydrofuran-dimethanol, 9.9 parts of isosorbide and 5.4 parts of a solution of titanium isopropoxide in toluene (1% by weight of titanium isopropoxide) are placed in a reactor. The mixture is stirred using a magnetic bar and is heated to 160° C. over the course of 30 min under a nitrogen stream. Still under nitrogen stream, the mixture is then maintained at 160° C. for 1 h, before being again heated to 190° C. over the course of 30 min. This temperature is maintained for 2 h in order to remove the maximum amount of methanol.

Following this, the reactor temperature is increased to 240° C., and the pressure is reduced over the course of 90 min to 0.7 mbar with magnetic stirring. These conditions are maintained for 3 h.

The characteristics of the polymer formed are reported in table 2 below.

### Example According to the Invention (Ex. 7)

50 parts of dimethyl furanoate, 12.8 parts of ethylene glycol, 36.4 parts of tetrahydrofuran-dimethanol, 9.5 parts of isosorbide and 7.1 parts of a solution of titanium isopropoxide in toluene (1% by weight of titanium isopropoxide) are placed in a reactor. The mixture is stirred by mechanical stirring at 150 rpm and placed in an oven heated to 180° C. over the course of 15 min under a nitrogen stream. Still under a nitrogen stream, the oven is then maintained at 180° C. for 1 h, before being again heated to 210° C. over the course of 1 h. This temperature is maintained for 2 h in order to remove the maximum amount of methanol.

Following this, the oven temperature is increased to 260° C., the pressure is reduced over the course of 90 min to 0.7 mbar and the stirring speed is reduced to 50 rpm. These conditions are maintained for 3 h.

The characteristics of the polymer formed are reported in table 2 below.

### Example According to the Invention (Ex. 8)

50.1 parts of dimethyl furanoate, 9.8 parts of ethylene glycol, 43 parts of tetrahydrofuran-dimethanol, 13.8 parts of isosorbide and 5.2 parts of a solution of titanium isopropoxide in toluene (1% of titanium isopropoxide) are placed in a reactor. The mixture is stirred using a magnetic bar and is heated to 160° C. over the course of 30 min under a nitrogen stream. Still under nitrogen stream, the mixture is then maintained at 160° C. for 1 h, before being again heated to 190° C. over the course of 30 min. This temperature is maintained for 2 h in order to remove the maximum amount of methanol.

Following this, the reactor temperature is increased to 240° C., and the pressure is reduced over the course of 90 min to 0.7 mbar with magnetic stirring. These conditions are maintained for 3 h.

The characteristics of the polymer formed are reported in table 2 below.

### Example According to the Invention (Ex. 9)

50 parts of dimethyl furanoate, 17.1 parts of ethylene glycol, 7.7 parts of tetrahydrofuran-dimethanol, 31.3 parts of isosorbide and 5 parts of a solution of titanium isopropoxide in toluene (1% of titanium isopropoxide) are placed in a reactor. The mixture is stirred using a magnetic bar and is heated to 160° C. over the course of 30 min under a nitrogen stream. Still under nitrogen stream, the mixture is then maintained at 160° C. for 1 h, before being again heated to 190° C. over the course of 30 min. This temperature is maintained for 2 h in order to remove the maximum amount of methanol.

Following this, the reactor temperature is increased to 240° C., and the pressure is reduced over the course of 90 min to 0.7 mbar with magnetic stirring. These conditions are maintained for 3 h.

The characteristics of the polymer formed are reported in table 2 below.

### Example According to the Invention (Ex. 10)

50.2 parts of dimethyl furanoate, 58.5 parts of tetrahydrofuran-dimethanol, 16.6 parts of isosorbide and 5.6 parts of a solution of titanium isopropoxide in toluene (1% of titanium isopropoxide) are placed in a reactor. The mixture is stirred using a magnetic bar and is heated to 160° C. over the course of 30 min under a nitrogen stream. Still under nitrogen stream, the mixture is then maintained at 160° C. for 1 h, before being again heated to 190° C. over the course of 30 min. This temperature is maintained for 2 h in order to remove the maximum amount of methanol.

Following this, the reactor temperature is increased to 240° C., and the pressure is reduced over the course of 90 min to 0.7 mbar with magnetic stirring. These conditions are maintained for 3 h.

The characteristics of the polymer formed are reported in table 2 below.

### Example According to the Invention (Ex. 11)

50.2 parts of dimethyl furanoate, 35.6 parts of tetrahydrofuran-dimethanol, 8.9 parts of tetramethylcyclobutanediol, 10.3 parts of ethylene glycol and 5.7 parts of a solution of titanium isopropoxide in toluene (1% of titanium isopropoxide) are placed in a reactor. The mixture is stirred using a magnetic bar and is heated to 160° C. over the course of 30 min under a nitrogen stream. Still under nitrogen stream, the mixture is then maintained at 160° C. for 1 h, before being again heated to 190° C. over the course of 30 min. This temperature is maintained for 2 h in order to remove the maximum amount of methanol.

Following this, the reactor temperature is increased to 240° C., and the pressure is reduced over the course of 90 min to 0.7 mbar with magnetic stirring. These conditions are maintained for 3 h.

The characteristics of the polymer formed are reported in table 2 below.

### Example According to the Invention (Ex. 12)

49.9 parts of dimethyl furanoate, 44.9 parts of tetrahydrofuran-dimethanol, 32.3 parts of tetramethylcyclobutanediol and 6.3 parts of a solution of titanium isopropoxide in toluene (1% of titanium isopropoxide) are placed in a reactor.

The mixture is stirred using a magnetic bar and is heated to 160° C. over the course of 30 min under a nitrogen stream. Still under a nitrogen stream, the mixture is then maintained at 160° C. for 1 h, before being again heated to 190° C. over the course of 30 min. This temperature is maintained for 2 h in order to remove the maximum amount of methanol.

Following this, the reactor temperature is increased to 240° C., and the pressure is reduced over the course of 90 min to 0.7 mbar with magnetic stirring. These conditions are maintained for 3 h.

The characteristics of the polymer formed are reported in table 2 below.

TABLE 2
Properties of polyesters according to the invention
comprising various cyclic aliphatic diol units (C2)

| Exam- | Nature of cyclic aliphatic | Tg | A/C1/C2 | Mw |
|---|---|---|---|---|
| ples | diol C2 | (° C.) | (mol/mol/mol) | (g/mol) |
| 6 | isosorbide | 61.2 | 73.2/19.7/7.1 | 46 700 |
| 7 | isosorbide | 64 | 72.5/18.5/9 | 52 500 |
| 8 | isosorbide | 58.1 | 77.1/15/7.1 | 45 400 |
| 9 | isosorbide | 83.6 | 19.6/48.6/31.8 | 20 400 |
| 10 | isosorbide | 60 | 88.1/0/11.9 | 142 300 |
| 11 | tetramethylcyclobutanediol | 50 | 88.1/5/6.9 | 18 750 |
| 12 | tetramethylcyclobutanediol | 54 | 87.9/0/12.1 | 18 700 |

All the polymers according to the invention are amorphous. Furthermore, these tests show that it is also possible to modulate the glass transition temperature by adding other monomers to the polyester, and in particular other monomers of cycloaliphatic diol type other than tetrahydrofuran-dimethanol.

1. A thermoplastic polyester comprising:
at least one tetrahydrofuran-dimethanol diol unit (A);
at least one furandicarboxylic acid unit (B);
at least one aliphatic diol unit (C) other than the diol (A).

2. The polyester as claimed in claim 1, wherein the polyester has a degree of crystallinity of less than 50%, advantageously less than 35%.

3. The amorphous polyester as claimed in claim 1, wherein the polyester is amorphous.

4. The polyester as claimed in claim 1, wherein the polyester has a weight-average molar mass of greater than 7500 g/mol, preferably greater than 10 000 g/mol, most preferentially greater than 20 000 g/mol.

5. The polyester as claimed in claim 1, wherein the aliphatic diol unit (C) is at least one unit chosen from linear aliphatic diols (C1), cycloaliphatic diols (C2), branched aliphatic diols (C3), or a mixture of these units.

6. The polyester as claimed in claim 5, wherein the aliphatic diol unit (C) is a linear aliphatic diol unit (C1) or a mixture of these units (C1).

7. The polyester as claimed in claim 6, wherein the polyester comprises, relative to the total amount of diol units (A) and (C1):
from 1 to 99 units (A), advantageously from 5 to 90, preferentially from 10 to 80, for example from 20 to 75;
and from 1 to 99 units (C1), advantageously from 10 to 95, preferentially from 20 to 90, for example from 25 to 80.

8. The polyester as claimed in claim 5, wherein the aliphatic diol unit (C) is a cycloaliphatic diol unit (C2) or a mixture of these units (C2).

9. The polyester as claimed in claim 8, wherein the polyester comprises, relative to the total amount of diol units (A) and (C2):
from 1 to 99 units (A), advantageously from 5 to 98, preferentially from 80 to 95;
and from 1 to 99 units (C2), advantageously from 2 to 95, preferentially from 5 to 20.

10. The polyester as claimed in claim 9, wherein the aliphatic diol unit (C) comprises at least one mixture of at least one linear aliphatic diol unit (C1) and of at least one cycloaliphatic diol unit (C2).

11. The polyester as claimed in claim 10, wherein the polyester comprises, relative to the total amount of diol units (A) and (C):
from 1 to 98 units (A), advantageously from 5 to 95, preferentially from 15 to 90;
from 1 to 98 units (C1), advantageously from 2 to 60, preferentially from 4 to 50;
and from 1 to 98 units (C2), advantageously from 2 to 60, preferentially from 5 to 40.

12. The polyester as claimed in claim 5, wherein the polyester comprises at least one linear aliphatic diol unit (C1) chosen from ethylene glycol, 1,3-propanediol, 1,4-butanediol, 1,5-pentanediol, 1,6-hexanediol, 1,8-octanediol, 1,10-decanediol, or a mixture of aliphatic diol units comprising at least one of these units.

13. The polyester as claimed in claim 5, wherein the polyester comprises at least one linear aliphatic diol unit (C1) chosen from ethylene glycol and 1,4-butanediol, very preferentially ethylene glycol.

14. The polyester as claimed in claim 5, wherein the cycloaliphatic diol unit (C2) comprises at least one unit chosen from the following units:

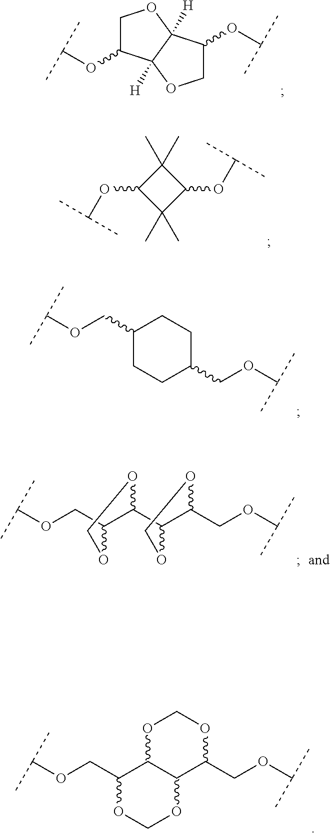

15. The polyester as claimed in claim 14, wherein the cycloaliphatic diol unit (C2) comprises at least one unit chosen from the following units: 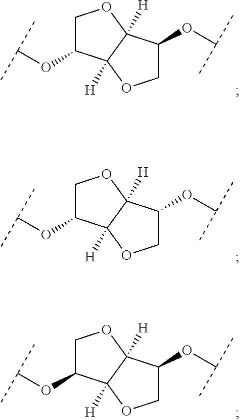
preferentially a unit:

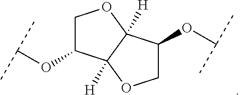

16. The polyester as claimed in claim 1, wherein the polyester comprises, relative to the total amount of diol units (A) and (C):
from 1 to 99 units (A), advantageously from 5 to 98;
and from 1 to 99 units (C), advantageously from 2 to 95.

17. The polyester as claimed in claim 1, wherein the glass transition temperature is greater than or equal to 50° C., preferably greater than or equal to 60° C.

18. A process for producing thermoplastic polyester, which comprises:
a step of introducing, into a reactor, monomers comprising at least one tetrahydrofuran-dimethanol diol (A), at least one furandicarboxylic acid (B) and/or a diester of this acid and at least one aliphatic diol (C) other than the diol (A); and
a step of polymerizing the monomers so as to form the polyester, comprising:
a first stage during which the reaction medium is stirred at a temperature ranging from 140 to 210° C. in order to form oligomers;
a second stage during which the oligomers formed are stirred under vacuum, at a temperature ranging from 200 to 275° C. in order to form the polyester;
a step of recovering the polyester at the end of the polymerizing step.

19. The process as claimed in claim 18, wherein, relative to the total moles of monomers (A), (B) and (C) introduced into the reactor, the molar percentage of acid and/or of acid diester (B) ranges from 25% to 45%.

20. A polyester that can be obtained according to the process of claim 18.
